(19) United States
(12) Patent Application Publication
(10) Pub. No.: US 2007/0297716 A1
(43) Pub. Date: Dec. 27, 2007

(54) Reconfigurable photonic delay line filter

(76) Inventors: Roger Jonathan Helkey, Montecito, CA (US); John Edward Bowers, Santa Barbara, CA (US); Volkan Kaman, Santa Barbara, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/821,219

(22) Filed: Jun. 21, 2007

Related U.S. Application Data
(60) Provisional application No. 60/816,219, filed on Jun. 23, 2006.

(51) Int. Cl. G02B 6/26

(52) U.S. Cl. 385/16

(57) ABSTRACT

A filter apparatus is described that includes an electrical input signal, an optical source, an optical modulator, first and second pluralities of photonic delay lines, an optical switch, a combiner, and a photodetector. The optical modulator is coupled to the electrical input signal and the optical source. The first plurality of photonic delay lines are coupled to the optical modulator. The optical switch is coupled to the optical switch. The combiner combines the outputs of the second plurality of photonic delay lines to provide a combined output. The photodetector is coupled to the combined output of the combiner to provide a first filtered output of the electrical input signal.

### CROSS REFERENCE TO RELATED APPLICATION

This application claims the priority benefit of U.S. Provisional Patent Application No. 60/816,219, filed Jun. 23, 2006, which is hereby incorporated by reference.

### FIELD

Embodiments of the present invention relate to tunable high-bandwidth electrical filters.

### BACKGROUND

High frequency reconfigurable filters have a number of applications, including the selection of received signals from broadband microwave antennas. Other reconfigurable filter applications include matched filtering, jammer nulling, and pulse compression. Electrical filters can be synthesized digitally, but are limited in bandwidth due to the limited speed of electrical circuits. High frequency filters have been demonstrated based on synthesizing transversal filter functions with optical fiber delays and varied tap weights, but the tenability of these optical delay configurations has been limited.

### SUMMARY

A filter apparatus is described that includes an electrical input signal, an optical source, an optical modulator, first and second pluralities of photonic delay lines, an optical switch, a combiner, and a photodetector. The optical modulator is coupled to the electrical input signal and the optical source. The first plurality of photonic delay lines are coupled to the optical modulator. The optical switch is coupled to the first plurality of photonic delay lines. The second plurality of photonic delay lines are coupled to the optical switch. The combiner combines the outputs of the second plurality of photonic delay lines to provide a combined output. The photodetector is coupled to the combined output of the combiner to provide a first filtered output of the electrical input signal.

The other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a reconfigurable photonic delay line filter configuration;

FIG. 2 shows an alternative source module embodiment;

FIG. 3A shows a measured transversal filter response for a 6 gigahertz bandpass filter;

FIG. 3B shows a measured transversal filter response for a 10 gigahertz bandpass filter;

FIG. 4A shows calculated filter responses using standard tap delays;

FIG. 4B shows calculated filter responses using 25 times longer delay taps, resulting in bandwidth reduction but resulting in repetitive passbands;

FIG. 5 shows a passband selector configuration.

### DETAILED DESCRIPTION

A system is described for constructing programmable electrical filter functions. Programmable electrical filters that operate at very high electrical frequencies can be constructed using this configuration by using high-frequency optical elements to form the filter, with operation possible at frequencies higher than 40 GHz. An input electrical signal is used to modulate an optical signal. The optical signal is split into multiple modulated optical signals, each of the multiple modulated optical signals receiving a first range of input optical delays. An optical switch connects these delayed optical signals to a second range of output optical delays. By connecting large numbers of input and output optical delays with a large optical switch, large numbers of total delay values can be fabricated. For example, a switch with 300 input ports and 300 output ports provides the capability of fabricating 90,000 different delay values. The large number of possible delays allows this configuration to generate a larger variation of high-frequency filter functions than has been possible with previous configurations.

Long delays can be used to form very narrow filter pass bands or stop bands over a desired frequency range, although with possibly undesirable additional filter pass bands or stop bands at other frequencies. The amplitudes of the delayed signals are set by adjusting the loss of the optical switch connections. The signals from the output optical delays are combined to form a first filter function with multiple pass bands. The multiple optical signals from the output optical delays include multiple optical wavelengths to minimize overall optical loss. An electrical signal is generated by detecting the amplitude of the optical signal resulting by combining the multiple optical signals having different optical delays. A second filter function is cascaded to select a single pass band from the first filter function containing multiple filter pass bands.

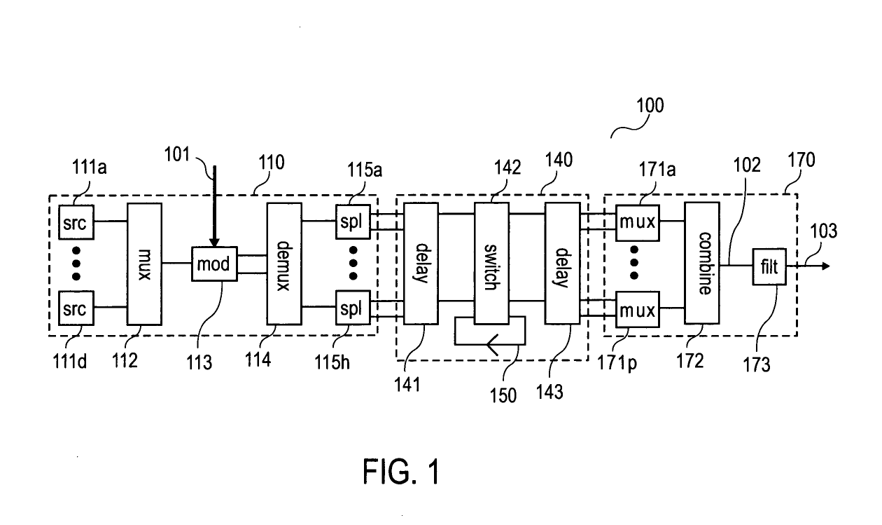

An embodiment of the invention is shown in FIG. 1. Optical source module 110 produces an array of sixty-four fiber-coupled optical signals modulated by input signal 101. An array of four low noise optical sources 111a-111d provide fiber-coupled optical power at four separate wavelengths. An optical multiplexer 112 combines the four wavelengths into a single optical fiber, which is connected to the optical input of optical modulator 113. Input signal 101 modulates the intensity of the optical power from multiplexer 112, producing two fiber-coupled outputs with complementary intensity modulation, each output carrying four optical wavelengths. Optical demultiplexer 114 divides each of the two modulated signals from modulator 113 into 4 fiber-coupled outputs each carrying a single wavelength. Optical splitters 115a-115h each split an output of demultiplexer 114 carrying a single wavelength into eight approximately equal outputs each carrying a single wavelength, resulting in the sixty-four fiber coupled outputs of module 110, each output carrying a single wavelength modulated by input signal 101.

Optical delay module 140 has sixty-four inputs from optical source module 110 connected to an array 141 of sixty-four photonic input delays consisting of optical waveguides of varying lengths.

Optical switch 142 connects an array 141 of sixty-four input delays to an array 143 of sixty-four photonic output delays. Optical switch 142 is a 64×64 port optical switch that switches optical beams in free-space using two arrays of MEMS micromirrors that rotate in two axes. These optical switches are available from Calient Networks of San Jose, Calif. For one embodiment, optical switch 142 is fully nonblocking, connecting any input port to any output port. For other embodiments, optical switch 142 is partially blocking, and connects any port of photonic input delays 141 only to certain ports of photonic output delays 143.

For another embodiment there is only one optical source 111, and no multiplexer 112 or demultiplexer 114. For another embodiment, there is only a single optical output from modulator 113. For other embodiments, additional paths 150 are used to connect output ports to input ports of switch 142, allowing additional flexibility in tailoring filter functions. The delay of these feedback paths 150 should be well characterized in order to be used to generate desired filter delays using these feedback paths 150. Optical amplification may be used in these feedback paths 150 in order to reduce the effect of optical switch loss.

For one embodiment, the photonic delays 141 and 143 consist of varying lengths of optical fiber. For another embodiment, the photonic delays comprise other methods of optical delay known to the art, such as different lengths of planar waveguides, for example silicon dioxide waveguides on a glass substrate. For one embodiment, photonic input delays 141 vary in delay over a range of 200 ps, and photonic output delays 143 vary in delay over a range of 6 ns.

Combiner module 170 combines the sixty-four outputs of optical delay module 140. Sixteen multiplexer modules 171a-171p each combine four wavelengths that were generated from the four optical sources 111a-111d. Electrical combiner 172 converts the modulated optical signals from the sixteen multiplexers 171a-171p to electrical signals using sixteen photodetectors, then electrically sums the sixteen recovered electrical modulation signals using electrical power combiners such as Narda #4426-8 from Narda Microwave of Hauppauge, N.Y.

For another embodiment, the sixteen photodetectors of combiner 172 are fabricated on a semiconductor integrated circuit with a traveling wave amplifier to combine the electrical signals from each of the sixteen photodetectors with minimal signal to noise degradation. For another embodiment there are no multiplexers 171. For another embodiment, combiner 172 is replaced by a single photodetector.

For another embodiment, the sixty-four optical signals from delay lines 143 are combined onto sixteen multiplexers/photodetectors 171a-171p using free-space optical beams, wherein four free-space optical beams from delay lines 143 are multiplexed onto each photodetector 171 by illuminating each photodetector at four different angles in order to sum the power of the four free-space optical beams without any effect of the phase of these optical signals. The sixteen electrical signals from multiplexers/photodetectors 171a-171p are combined into a single electrical signal using electrical power combiner 172.

The output of electrical combiner 172 is proportional to the electrical input 101 modified by a filter function with multiple passbands, where the passbands are set by the delays in photonic input delays 141 and photonic output delays 143, which in turn are selected using optical switch 142. The filter function also depends on the optical loss through each of the paths set up by switch 142, which can be controlled by attenuating paths through optical switch 142 using non-optimal mirror alignment to increase the optical loss, or with external variable optical attenuators to add additional optical loss. Additional filter selectivity is obtained using electrical filter 173, which may be used to select one of multiple filter passbands at the output of electrical combiner 172, and produces an electrical output 103 with a single filter passband. For another embodiment, filter 173 is omitted.

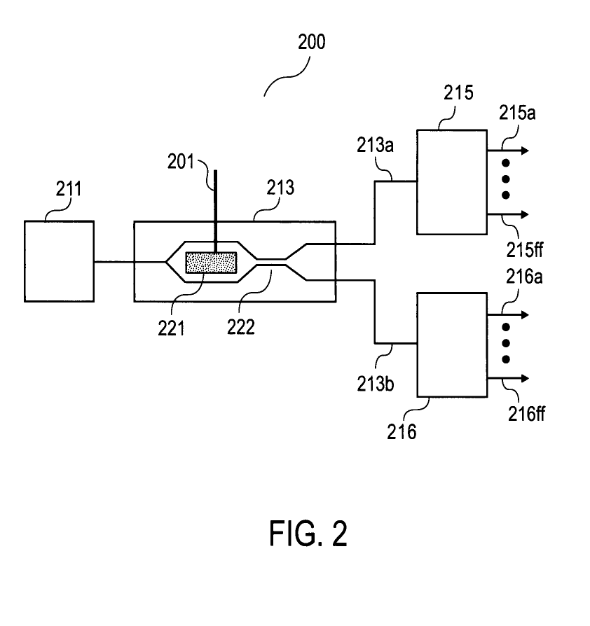

FIG. 2 shows an alternate embodiment 200 of optical source module 110. A single optical source 211 is used to drive optical modulator 213. Optical modulator 213 is identical in function to optical modulator 113 of FIG. 1, and uses an electrode 221 on a Lithium Niobate substrate to generate a phase difference between two optical inputs to combiner 222. Phase changes proportional to input voltage 201 produce complementary amplitude changes in complementary outputs 213a and 213b. Optical modulators with complementary optical outputs are available from EOSpace of Redmond, Wash. Two 32-way optical power splitters 215 and 216 are used to generate the sixty-four outputs 215a-215ff and 216a-216ff of optical source module 200. These 32-way optical power splitters are available from ANDevices of Fremont, Calif.

Other known methods of optical modulation may be employed, including modulation of semiconductor laser sources by modulation of injected electrical current. Similarly, wavelength dependent combiners 171a-171p of FIG. 1 may be omitted, and combiner 172 may have 64 wavelength independent inputs.

The amplitude and delays of desired filter tap weights can be generated from a Fourier transform of the amplitude and phase of a desired filter function. Methods of generating tap amplitudes and delays to produce a desired filter function are well known to the art.

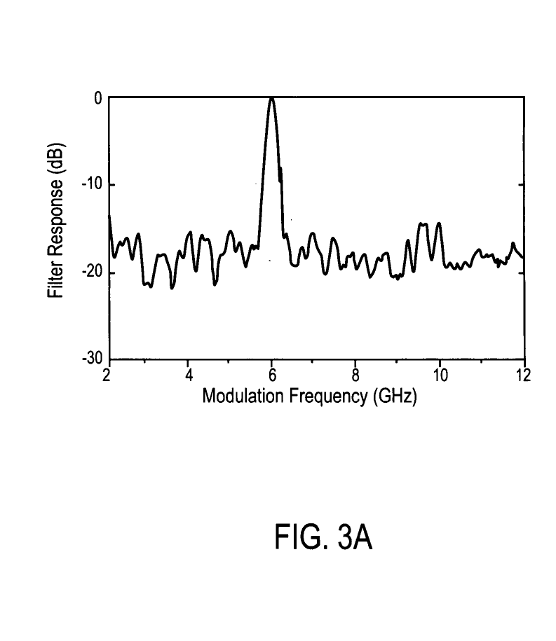

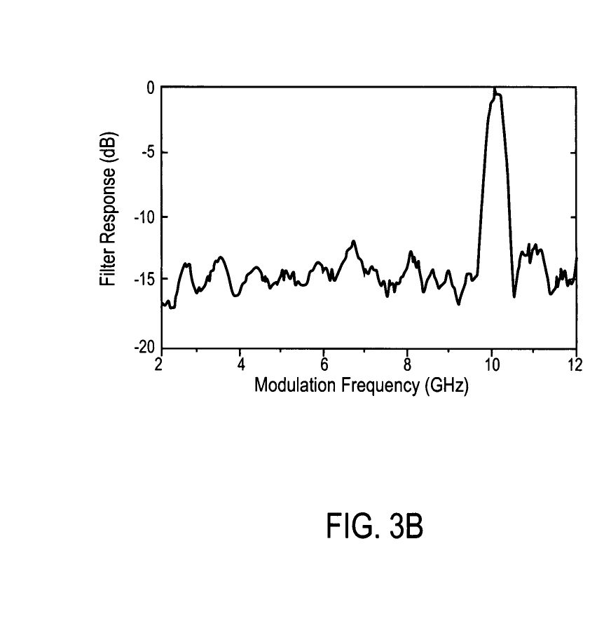

Measured transversal filter functions are shown in FIGS. 3A and 3B, produced by configuration 100 of FIG. 1 together with wavelength independent splitters and combiners shown in FIG. 2. The tap delays were selected to provide filter tuning over an octave-wide operating bandwidth from 6 GHz to 12 GHz. Sixty-four output delays were selected over a range of 6 ns to provide coarse selection of the desired delay. Sixty-four input delays over a range of 0.2 ns were selected to provide a range of fine delays. Appropriate coarse and fine delays were then selected in order to form the desired total optical delay for each filter tap, this total delay consisting of the sum of the input and output fiber delays plus the internal optical delay of the optical switch.

The delay of optical switch 142 may vary due to differences in internal optical path length depending on the input and output ports chosen for the optical switch connection. This optical switch delay needs to be accounted for when selecting the optimum input and output fiber delays.

A 6 GHz bandpass filter shown in FIG. 3A was fabricated using one set of optical switch 142 settings to interconnect input delays 141 and output delays 143 of FIG. 1. A 10 GHz bandpass filter function shown in FIG. 3B used a different set of switch 142 settings with the same set of input delays 141 and output delays 143.

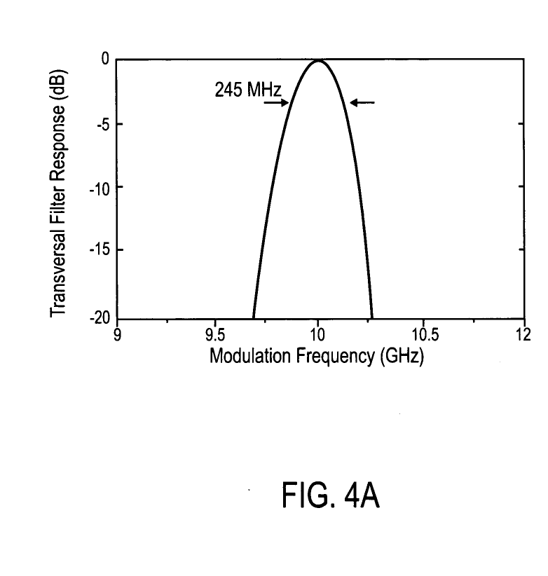

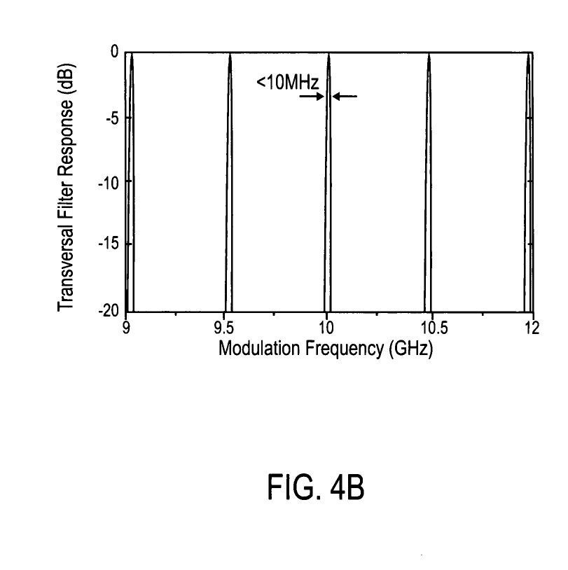

In many applications it is desired to achieve the narrowest possible filter bandwidth. This minimum achievable filter bandwidth was limited by the design requirement to avoid any spurious passband responses over the octave 6-12 GHz operating bandwidth. For a given number of taps, the minimum filter bandwidth can be considerably reduced by increasing the lengths of the coarse fiber delays, at the expense of secondary pass bands. The calculated filter response for a 10 GHz reconfigurable transversal filter with an octave of spurious-free response is shown in FIG. 4A, with a 245 MHz passband for a 64-port switch configuration. This passband can be reduced to <10 MHz as shown in FIG. 4B by increasing the coarse delays by a ratio of twenty five, although this increased tap delay length results in distinct separate pass bands spaced about 480 MHz apart, each pass band having a separate distinct center frequency.

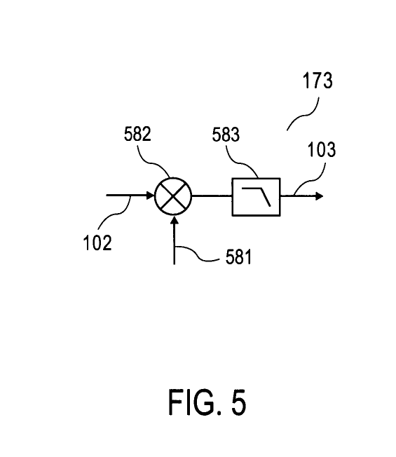

Electrical filter 173 of FIG. 1 is used to suppress all but one of the passbands shown in FIG. 4B. An embodiment of tunable filter 173 is shown in FIG. 5. Filter output 102 with multiple passbands is down-converted to a lower frequency signal using a tunable local oscillator 581 and a mixer 582. The mixer 582 is followed by a fixed filter 583 to suppress undesired frequency mixing products from mixer 582, yielding an output 103.

For another embodiment, the frequency conversion of mixer 582 is performed by the sampling in a analog to digital converter 582, and the filter 583 is a digital filter. For another embodiment, the frequency mixing is performed by using a pulsed laser 211 of FIG. 2, resulting in frequency mixing in the photodetection of combiner 172 in FIG. 1. In this pulsed laser mixing embodiment, mixer 582 is not needed, but filter 583 is still used to reject undesired mixing products.

In the foregoing specification, the invention has been described with reference to specific exemplary embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A filter apparatus comprising:
an electrical input signal;
an optical source;
an optical modulator coupled to the electrical input signal and to the optical source;
a first plurality of photonic delay lines coupled to the optical modulator;
an optical switch coupled to the first plurality of photonic delay lines;
a second plurality of photonic delay lines coupled to the optical switch;
a combiner to combine the outputs of the second plurality of photonic delay lines to provide a combined output;
a photodetector coupled to the combined output of the combiner, wherein the photodetector produces a first filtered output of the electrical input signal.

2. The apparatus of claim 1, wherein the optical source contains more than one wavelength.

3. The apparatus of claim 2, further comprising a wavelength demultiplexer residing between the optical modulator and the first plurality of photonic delay lines.

4. The apparatus of claim 2, further comprising a wavelength multiplexer residing between the second plurality of photonic delay lines and the photodetector.

5. The apparatus of claim 1, further comprising optical connections from an output of the optical switch to an input of the optical switch.

6. The apparatus of claim 1, wherein outputs from second plurality of photonic delay lines are combined in free-space at the photodetector.

7. The apparatus of claim 1, further comprising a plurality of photodetectors coupled to the second plurality of photonic delay lines.

8. The apparatus of claim 7, further comprising an electrical combiner coupled to the plurality of photodetectors.

9. The apparatus of claim 8, wherein the electrical combiner is integrated with electrical amplifiers on a semiconductor substrate.

10. The apparatus of claim 1, wherein the filter apparatus produces multiple bandpass filter pass bands, further comprising a mechanism to select one or more of the multiple distinct bandpass filter pass bands and suppress one or more of the multiple distinct bandpass filter pass bands.

11. The apparatus of claim 10, wherein the mechanism to select one or more of the multiple distinct bandpass filter passbands comprises a frequency conversion stage that changes the frequency of the electrical input signal, and a fixed bandpass filter producing a second filtered output of the electrical signal.

12. The apparatus of claim 10, wherein the mechanism to select one or more of the multiple distinct bandpass filter passbands comprises an analog to digital converter.

13. The apparatus of claim 10, wherein the mechanism to select one or more of the multiple distinct bandpass filter passbands comprises a pulsed optical source that alters the frequency of the electrical input signal by nonlinear mixing in the photodetector.

14. The apparatus of claim 10, wherein the mechanism to select one or more of the multiple distinct bandpass filter passbands comprises a tunable electrical bandpass filter.

15. A filter apparatus comprising:
an input electrical signal;
an optical modulator coupled to the input signal and to an optical source containing more than one wavelength;
a first plurality of photonic delay lines coupled to the optical modulator;
an optical switch coupled to the first plurality of photonic delay lines;
a second plurality of photonic delay lines coupled to the optical switch;
means for combining outputs of the second plurality of photonic delay lines;
a photodetector coupled to a combined output of the second plurality of photonic delay lines, wherein the photodetector produces a first filtered output of the electrical input signal, the filtered output containing more than one distinct pass band, each distinct pass band having a different center frequency.

16. A method of filtering an input electrical signal, comprising:
modulating an optical signal with input electrical signal;
splitting the optical signal into multiple input signals;
delaying the multiple input signals;
switching the optical input signals to optical output signals;
adjusting the amplitudes of the optical output signal;
delaying the optical output signals;
summing the optical output signals; and
detecting the optical output signals to produce an output optical signal that is a filtered version of the input electrical signal.

17. The method of claim 16, wherein summing and detecting the optical signals comprises summing the optical signals followed by detecting the optical signals, or detecting the optical signals followed by summing the optical signals.

18. The method of claim 16, wherein summing and detecting the optical signals comprises summing multiple sets of optical signals, detecting multiple sets of summed optical signals, then summing the multiple sets of detected, summed optical signals.

19. The method of claim 16, wherein modulating the optical signal with the input electrical signal comprises:
generating multiple optical wavelengths;
combining the multiple optical wavelengths into a smaller number of optical wavelengths;
modulating the intensity of the combined multiple optical wavelengths;
separating the different optical wavelengths; and
providing different optical delay for different wavelengths.

20. The method of claim 16, wherein the filtered output produced by summing and detecting the optical output signals from the switch contains more than one distinct pass band, each distinct pass band having a different center frequency.

21. The method of claim 16, further comprising an electrical filter following the summed and detected optical signals, the electrical filter reducing the number of distinct filter pass bands.
